(19) United States
(12) Patent Application Publication
(10) Pub. No.: US 2014/0266885 A1
(43) Pub. Date: Sep. 18, 2014

(54) SYSTEMS AND METHODS FOR MAINTAINING TIME SYNCHRONIZATION

(71) Applicant: NextNav, LLC, Sunnyvale, CA (US)

(72) Inventors: Arun Raghupathy, Bangalore (IN); Jagadish Venkataraman, San Jose, CA (US)

(73) Assignee: NextNav, LLC, Sunnyvale, CA (US)

(21) Appl. No.: 14/207,453

(22) Filed: Mar. 12, 2014

Related U.S. Application Data
(60) Provisional application No. 61/786,574, filed on Mar. 15, 2013.

(51) Int. Cl. G01S 19/24

(52) U.S. Cl. CPC G01S 19/24
USPC 342/357.63

(57) ABSTRACT

Described are systems and methods for time synching.

### CROSS REFERENCE TO RELATED APPLICATIONS

This application claims priority under 35 U.S.C. §119(e) to co-pending U.S. Provisional Patent Application Ser. No. 61/786,574, filed Mar. 15, 2013, entitled TECHNIQUES FOR MAINTAINING TIME SYNC WITH GPS PPS IN GPS-CHALLENGED ENVIRONMENTS, the content of which is hereby incorporated by reference herein in its entirety for all purposes.

### FIELD

Various embodiments relate to time synching to a network.

### BACKGROUND

There is a need for improved techniques for maintaining time synchronization in GPS challenged environments.

### SUMMARY

Certain embodiments of this disclosure relate generally to time synching with GPS PPS in GPS-challenged environments.

### DRAWINGS

FIG. 1A depicts an urban canyon environment.

FIG. 1B depicts an adaptive masking scheme.

FIGS. 2-13 illustrate experimental results.

### DESCRIPTION

Various aspects of the invention are described below. It should be apparent that the teachings herein may be embodied in a wide variety of forms and that any specific structure, function, or both, being disclosed herein is merely representative. Based on the teachings herein one skilled in the art should appreciate that any aspect disclosed may be implemented independently of any other aspects and that two or more of these aspects may be combined in various ways. For example, a system may be implemented or a method may be practiced using any number of the aspects set forth herein.

As used herein, the term “exemplary” means serving as an example, instance or illustration. Any aspect and/or embodiment described herein as “exemplary” is not necessarily to be construed as preferred or advantageous over other aspects and/or embodiments.

In the following description, numerous specific details are introduced to provide a thorough understanding of, and enabling description for, the systems and methods described. One skilled in the relevant art, however, will recognize that these embodiments can be practiced without one or more of the specific details, or with other components, systems, and the like. In other instances, well-known structures or operations are not shown, or are not described in detail, to avoid obscuring aspects of the disclosed embodiments.

### Overview

Various aspects, features, and functions are described below in conjunction with the appended Drawings. While the details of the embodiments of the invention may vary and still be within the scope of the claimed invention, one of skill in the art will appreciate that the Drawings described herein are not intended to suggest any limitation as to the scope of use or functionality of the inventive aspects. Neither should the Drawings and their description be interpreted as having any dependency or requirement relating to any one or combination of components illustrated in those Drawings.

A GPS disciplined oscillator (GPSDO) is a very accurate clock source that provides a pulse-per-second (PPS) output (and usually, also a 10 MHz output) that is in sync with GPS time. Typically, it includes a voltage-controlled oscillator (VCXO) in closed-loop with a GPS receiver under open-sky conditions such that the VCXO constantly tunes its frequency to adjust to the rising and setting of GPS satellites through the day. The GPS receiver mostly operates in a timing-only mode—e.g., it is placed in a pre-surveyed location such that it does not have to compute a position estimate, but only a timing solution to control the VCXO. The GPSDO output can then act as a very reliable clock source for transmission of signal from a base station synchronized to GPS time with a frequency as accurate as GPS oscillators. With a set of geographically separated GPSDOs, geographically separated transmissions from a set of base stations synchronized to each other and to GPS time is made possible.

The successful operation of a GPSDO is contingent on constant visibility of at least one GPS satellite (assuming the GPS receiver is in timing-only mode). However, there may be scenarios where the base station will have to be installed in challenging locations for GPS, like an urban canyon formed by buildings and other obstructions affecting line-of-sight communications between base station and GPS satellites. Such locations are rife with the possibility of reflected signals from the satellites reaching the GPS receiver in which case the computed PPS will be inaccurate. In order to work around this problem, the receiver can operate using a high elevation cut-off mask—e.g., not use satellites that are below a certain elevation in order to ensure line-of-sight measurements. However, in doing so, there is no guarantee that there will always be at least one visible satellite above the chosen elevation angle, especially if the mask angle needs to be set greater than 60 degrees to avoid obstructions in all radial directions. In such cases, the GPS receiver experiences significant outage times, preventing the GPSDO from operating in closed loop and thus, rendering the PPS output of the GPSDO less useful or completely useless.

Various solutions are disclosed herein, including a two-level approach to allow the PPS coming out of the GPSDO to stay closely in sync with GPS PPS at all times in spite of outages. At a first level, an adaptive masking scheme that tailors itself to suit the particular location of the GPS receiver may be used to reduce the duration of GPS satellite outages. This scheme may not entirely eliminate the possibility of outages, but will aim to significantly reduce their durations. At the second level, when these inevitable outages do happen, the VCXO may operate in an open-loop mode by controlling the parameters of its PLL using a combination of the control parameters saved from durations of closed loop operation (i.e., in absence of GPS outage) and the short term variations of control parameters extracted in real time from a similar GPSDO operating in closed loop mode while having clear view of sufficient GPS satellites.

Although a GPSDO is discussed using a GPS receiver, the GPS receiver can be replaced by a receiver that tracks one or more satellites or terrestrial systems to provide timing. Some examples of satellite systems are Glonass, Galileo, Beidou, Gagan, WAAS, MSAS and EGNOS.

The following section illustrates the adaptive masking scheme.

### Adaptive Masking

As can be seen from FIG. 1A, a GPS receiver located in an urban canyon is bound to be surrounded by high-rises along most directions, thus, rendering most of the GPS signal reaching the receiver multipath-heavy. Since the receiver is part of a static base-station whose position coordinates can be pre-determined, it can operate in a timing-only mode needing to receive a line-of-sight signal from just one satellite. Thus, one solution is for the GPS receiver to operate by choosing an elevation mask angle that will make it more likely to obtain multipath-free reception from satellites all around the sky (i.e., for all azimuthal angles).

For the sample location shown in FIG. 1, an elevation angle that would universally solve the multipath problem from all azimuthal directions is close to 75 degrees. Over the course of a day, however, the probability of at least one satellite being present above that angle is only 10% (for a chosen sample location). Accordingly, the GPS receiver will be in outage the remaining 90% of the time. During this long outage time, the receiver's PPS will be out-of-sync with GPS PPS and cannot be used to discipline the VCXO effectively.

An alternate approach is to adapt the operation mode of the GPS receiver to its surroundings. If the receiver is located in a street that runs north-south, for instance, it is highly likely that the receiver is flanked by buildings of various heights (e.g., including high-rises) only on the east and west sides, and has relatively open view of the sky along the north-south direction. It is also true that not all the buildings are equally tall and that the elevation angle might improve along certain directions (e.g., a section of the street where flanking buildings are relatively low to permit a better elevation angle corresponding to satellites that may have previously been blocked by taller buildings). Thus, an adaptive masking scheme, as illustrated by FIG. 1B may be used as follows.

Step 110:

Select candidate GPS receiver locations within a particular environment. The receiver locations may be at ground level or at an elevated level (e.g., corresponding to a level of a building). It is noted that “ground level” may vary among candidate receiver locations. However, each location is positioned along a 2-dimension reference plane (e.g., a reference plane defined by latitude and longitude coordinates). Objects (or portions of objects) such as high-rise buildings, mountains, and other obstructions may be positioned throughout the corresponding reference plane along various azimuths.

Step 120:

Segment the reference plane into N “bins” corresponding to a range of azimuth(s) available, i.e., 360 degrees. The bins centers may or may not be uniformly spaced. The number N of bins may vary among different receiver locations. Moreover, the size of each bin (e.g., the range of angles) and the corresponding azimuths in each range may also vary among different receiver locations.

Step 130:

Survey the receiver's location (e.g., before the install) along the azimuths constituting the centers of the bins. For each bin, identify a minimum elevation angle that would increase the probability of multipath-free reception of the satellites in view based on the heights and proximity of surrounding objects distributed in the bin (i.e., the azimuth segment of the reference plane). It is noted that the elevation angles for particular bins may vary depending on the environment surrounding the receiver location.

Step 140:

Modify the receiver's operation algorithm such that it only tracks those satellites that satisfy the elevation angle constraint corresponding to the azimuths along which they are visible.

The above 4 steps significantly reduce the outage time of the receiver since the elevation angle constraints are bound to be low along some directions corresponding to particular bins of azimuths (e.g., where no objects obstruct the view to horizontal such as along a straight street, or where objects have low heights). Experiments have shown that, for example, in the sample location chosen the outage times over a day can reduce to 25% as opposed to the 90% seen with a single elevation mask angle constraint. Further, the outage time does not typically occur in a big burst of time but rather in small chunks of time spread throughout the day.

Despite the adaptive masking scheme, the VCXO will still need to put out a PPS in sync with GPS PPS during the outage times. This can be achieved by controlling the loop parameters of the VCXO's PLL. In order to illustrate this concept clearly, the following section will use a Rubidium (Rb) oscillator as a sample VCXO and demonstrate how PPS quality can be maintained within an accepted tolerance even during a GPS outage. The Rubidium oscillator exhibits, among other characteristics, relative low aging rate that make it a good component for network synchronization as disclosed herein. However, it is noted that other oscillators, e.g. a Cesium oscillator, may be used that exhibit similar characteristics.

### Rubidium Frequency Standard

The rubidium frequency standard operates by disciplining a crystal oscillator to the hyperfine transition at f_{Rb}=6.834682612 GHz in rubidium. Frequency offsets and long-term aging of the Rb oscillator can be eliminated by phase-locking to a source with better long-term stability, such as the 1 PPS from a GPS timing receiver. When an external 1 PPS signal is applied, the Rb oscillator will verify the integrity of that input and will then align its 1 PPS output with the external input. The processor will continue to track the 1 PPS output to the 1 PPS input by controlling the frequency of the rubidium transition with a small magnetic field adjustment inside the resonance cell.

Every Rb oscillator part will age differently. Also, the base-plate temperature varies from part-to-part and, together with aging, this determines the offset from f_{Rb} that is obtained when synchronizing the −Rb oscillator to GPS. This offset represents a long-term effect and is specific to a particular module. Consider, for example a pair of modules A and B that have offsets of f^{off}_{A} and f^{off}_{B} such that on initial sync up, the control loop parameter that adjusts the magnetic field so that the frequency of superfine transition is adjusted to the GPS pps based frequency, henceforth referred to as SF, values that the 2 modules settle at are SF_{A}=−|(f^{off}_{A/}f_{R}×10¹²)|, and SF_{B}=−|(f^{off}_{B/}f_{R}×10¹²)|, as shown below:

$${SF}_{A} = - ⌊ ( \frac{{f}_{A}^{off}}{{f}_{R}} \times {10}^{12} ) ⌋$$

$${SF}_{B} = - ⌊ ( \frac{{f}_{B}^{off}}{{f}_{R}} \times {10}^{12} ) ⌋$$

Now, once the long-term offset has been taken care of, the short term variation due to synchronization with GPS PPS should be similar across modules. For modules A and B, this variation will result in a Rb frequency of operation of f_{A}=f_{R}(1+f^{off}_{A/}f_{R}+SF_{A}+ΔSF_{A}), and f_{B}=f_{R}(1+f^{off}_{B/}f_{R}+SF_{B}+ΔSF_{B}), as shown below:

$${f}_{A} = {f}_{R} ( 1 + \frac{{f}_{A}^{off}}{{f}_{R}} + {SF}_{A} + Δ {SF}_{A} )$$

$${f}_{B} = {f}_{R} ( 1 + \frac{{f}_{B}^{off}}{{f}_{R}} + {SF}_{B} + Δ {SF}_{B} )$$

Given that SF_{A} and SF_{B} mostly cancel out the aging and temperature effects specific to A and B respectively, the short-term variation in SF should be similar, if not identical, for the 2 modules since they are synchronized to the same source. This would imply that

f_{A}=f_{B} [symbol] ΔSF_{A}=ΔSF_{B}

FIG. 2 shows the variation of ΔSF_{A} and ΔSF_{B} over 3 hours after the median SF value has been removed. It can be seen that the general short-term trend is similar for the 2 modules during this time. This information can be used to “transfer” SF values between modules. Thus, if module A is synchronized to GPS but B is not, module B can periodically ping A to determine the short-term variation in SF and adjust its SF accordingly. The definition of short-term can extend over a few hours comfortably as long as there is no major change in temperature of the 2 modules.

Note that when considering an alternate VCXO in place of an Rb oscillator, such as an ovenized voltage controlled OCXO, the voltage control will correspond to the SF control parameter. The voltage control will correspondingly have a long term component and a short term component as for the SF parameter.

### Experimental Results

The SF transfer method described above was tested using the following setup.

There are 2 Rbs (e.g., one in a van and another in a lab). Both Rbs are synchronized to their own GPS modules for approximately 24 hours. The van Rb is then unlocked at about 1930 hours and its SF value is set to the median SF that was observed throughout the day. From then on, every 10 seconds, the unlocked van Rb talked to the lab Rb to determine the change in SF. It then applied that change to its own SF value. This process continued for approximately 15 hours. Even though the van Rb was unlocked from GPS, it was still connected to the GPS PPS so that it could log its time tag throughout the unlocked period.

By way of illustration, FIG. 3 to FIG. 5 show the status of the Rb in the lab during these 15 hours. FIG. 6 to FIG. 8 show the status of the van Rb during this time. It is seen that as long as the van Rb's temperature is within a couple of degrees of where it started from, it exhibits virtually no drift. In fact, the drift has zero mean during this time. Once the van starts heating up after 9 AM in the morning, the SF transfer mechanism no longer holds and the van Rb starts drifting at approximately 20 ns/hr. This shows that the SF transfer mechanism holds water as long as the client Rb does not show wild swings in its temperature. If such swings are inevitable, some sort of temperature coefficient will have to be incorporated into the SF value on top of the delta value it gets from the server Rb.

In order to obtain a temperature coefficient for characterizing the SF variation, the Rb oscillator was locked to GPS over 4 days and its SF values were logged throughout the day as the van heated up and cooled down. The plots of the case temperature (quantized to 0.5 degree bins) variation with respect to the time of the day, SF with time of day and SF with respect to temperature are shown in FIGS. 9 to 11. Also shown in FIG. 11 are 2 fits to model the SF variation with respect to temperature, where one simply computes the median SF value for a given temperature, and the second computes a linear fit for the SF variation. FIG. 11 shows that the 2 models are comparable.

From the data shown in FIG. 11, the linear temperature coefficient for SF variation with respect to temperature was determined to be 1.3. This value is now used to steer the van Rb on top of the steering provided by the lab Rb. FIG. 12 shows the time tag variation on an unlocked Rb in the van over 14 hours. The van Rb was constantly talking to the Rb in the lab and updating its SF value. The time tag did not drift at all beyond the accepted tolerance levels. The variation of SF with respect to time shown in FIG. 13 looks quite similar to FIG. 9. Thus, via modeling the temperature coefficient of the −Rb oscillator and getting delta SF values from a master Rb oscillator in sync with GPS PPS all the time, it is possible to achieve drifts in the time tag values that are well within the operational margin.

Thus, the proposed adaptive masking scheme together with controlling the loop parameters of the VCXO's PLL can guarantee a PPS output that is in sync with GPS PPS during all times even in a GPS-challenged environment.

### Supporting Aspects

Various aspects relate to disclosures of other patent applications, patent publications, or issued patents. For example, each of the following applications, publications, and patents are incorporated by reference in their entirety for any and all purposes: United States Utility patent application Ser. No. 13/412,487, entitled WIDE AREA POSITIONING SYSTEMS, filed on Mar. 5, 2012; U.S. Utility patent Ser. No. 12/557,479 (now U.S. Pat. No. 8,130,141), entitled WIDE AREA POSITIONING SYSTEM, filed Sep. 10, 2009; United States Utility patent application Ser. No. 13/412,508, entitled WIDE AREA POSITIONING SYSTEM, filed Mar. 5, 2012; United States Utility patent application Ser. No. 13/296,067, entitled WIDE AREA POSITIONING SYSTEMS, filed Nov. 14, 2011; Application Serial No. PCT/US12/44452, entitled WIDE AREA POSITIONING SYSTEMS (WAPS), filed Jun. 28, 2011); U.S. patent application Ser. No. 13/535,626, entitled CODING IN WIDE AREA POSITIONING SYSTEMS (WAPS), filed Jun. 28, 2012; U.S. patent application Ser. No. 13/565,732, entitled CELL ORGANIZATION AND TRANSMISSION SCHEMES IN A WIDE AREA POSITIONING SYSTEM (WAPS), filed Aug. 2, 2012; U.S. patent application Ser. No. 13/565,723, entitled CELL ORGANIZATION AND TRANSMISSION SCHEMES IN A WIDE AREA POSITIONING SYSTEM (WAPS), filed Aug. 2, 2012; U.S. patent application Ser. No. 13/831,740, entitled SYSTEMS AND METHODS CONFIGURED TO ESTIMATE RECEIVER POSITION USING TIMING DATA ASSOCIATED WITH REFERENCE LOCATIONS IN THREE-DIMENSIONAL SPACE, filed Mar. 14, 2013. The above applications, publications and patents may be individually or collectively referred to herein as “incorporated reference(s)”, “incorporated application(s)”, “incorporated publication(s)”, “incorporated patent(s)” or otherwise designated. The various aspect, details, devices, systems, and methods disclosed herein may be combined with disclosures in any of the incorporated references in accordance with various embodiments.

This disclosure relates generally to positioning systems and methods for providing signaling for position determination and determining high accuracy position/location information using a wide area transmitter array of transmitters in communication with receivers such as in cellular phones or other portable devices with processing components, transceiving capabilities, storage, input/output capabilities, and other features.

Positioning signaling services associated with certain aspects may utilize broadcast-only transmitters that may be configured to transmit encrypted positioning signals. The transmitters (which may also be denoted herein as “towers” or “beacons”) may be configured to operate in an exclusively licensed or shared licensed/unlicensed radio spectrum; however, some embodiments may be implemented to provide signaling in unlicensed shared spectrum. The transmitters may transmit signaling in these various radio bands using novel signaling as is described herein or in the incorporated references. This signaling may be in the form of a proprietary signal configured to provide specific data in a defined format advantageous for location and navigation purposes. For example, the signaling may be structured to be particularly advantageous for operation in obstructed environments, such as where traditional satellite position signaling is attenuated and/or impacted by reflections, multipath, and the like. In addition, the signaling may be configured to provide fast acquisition and position determination times to allow for quick location determination upon device power-on or location activation, reduced power consumption, and/or to provide other advantages.

The receivers may be in the form of one or more user devices, which may be any of a variety of electronic communication devices configured to receive signaling from the transmitters, as well as optionally be configured to receive GPS or other satellite system signaling, cellular signaling, Wi-Fi signaling, Wi-Max signaling, Bluetooth, Ethernet, and/or other data or information signaling as is known or developed in the art. The receivers may be in the form of a cellular or smart phone, a tablet device, a PDA, a notebook or other computer system, and/or similar or equivalent devices. In some embodiments, the receivers may be a standalone location/positioning device configured solely or primarily to receive signals from the transmitters and determine location/position based at least in part on the received signals. As described herein, receivers may also be denoted herein as “User Equipment” (UE), handsets, smart phones, tablets, and/or simply as a “receiver.”

The transmitters may be configured to send transmitter output signals to multiple receiver units (e.g., a single receiver unit is shown in certain figures for simplicity; however, a typical system will be configured to support many receiver units within a defined coverage area) via communication links). The transmitters may also be connected to a server system via communication links, and/or may have other communication connections to network infrastructure, such as via wired connections, cellular data connections, Wi-Fi, Wi-Max, or other wireless connections, and the like.

Various embodiments of a wide area positioning system (WAPS), described herein or in the incorporated references, may be combined with other positioning systems to provide enhanced location and position determination. Alternately, or in addition, a WAPS system may be used to aid other positioning systems. In addition, information determined by receivers of WAPS systems may be provided via other communication network links, such as cellular, Wi-Fi, pager, and the like, to report position and location information to a server system or systems, as well as to other networked systems existing on or coupled to network infrastructure.

For example, in a cellular network, a cellular backhaul link may be used to provide information from receivers to associated cellular carriers and/or others via network infrastructure. This may be used to quickly and accurately locate the position of receiver during an emergency, or may be used to provide location-based services or other functions from cellular carriers or other network users or systems.

It is noted that, in the context of this disclosure, a positioning system is one that localizes one or more of latitude, longitude, and altitude coordinates, which may also be described or illustrated in terms of one, two, or three dimensional coordinate systems (e.g., x, y, z coordinates, angular coordinates, vectors, and other notations). In addition, it is noted that whenever the term ‘GPS’ is referred to, it is done so in the broader sense of Global Navigation Satellite Systems (GNSS) which may include other satellite positioning systems such as GLONASS, Galileo and Compass/Beidou. In addition, as noted previously, in some embodiments other positioning systems, such as terrestrially based systems, may be used in addition to or in place of satellite-based positioning systems.

Embodiments of WAPS include multiple transmitters configured to broadcast WAPS data positioning information, and/or other data or information, in transmitter output signals to the receivers. The positioning signals may be coordinated so as to be synchronized across all transmitters of a particular system or regional coverage area, and may use a disciplined GPS clock source for timing synchronization. WAPS data positioning transmissions may include dedicated communication channel resources (e.g., time, code and/or frequency) to facilitate transmission of data required for trilateration, notification to subscriber/group of subscribers, broadcast of messages, and/or general operation of the WAPS system. Additional disclosure regarding WAPS data positioning transmissions may be found in the incorporated references.

In a positioning system that uses time difference of arrival or trilateration, the positioning information typically transmitted includes one or more of precision timing sequences and positioning signal data, where the positioning signal data includes the location of transmitters and various timing corrections and other related data or information. In one WAPS embodiment, the data may include additional messages or information such as notification/access control messages for a group of subscribers, general broadcast messages, and/or other data or information related to system operation, users, interfaces with other networks, and other system functions. The positioning signal data may be provided in a number of ways. For example, the positioning signal data may be modulated onto a coded timing sequence, added or overlaid over the timing sequence, and/or concatenated with the timing sequence.

Data transmission methods and apparatus described herein may be used to provide improved location information throughput for the WAPS. In particular, higher order modulation data may be transmitted as a separate portion of information from pseudo-noise (PN) ranging data. This may be used to allow improved acquisition speed in systems employing CDMA multiplexing, TDMA multiplexing, or a combination of CDMA/TDMA multiplexing. The disclosure herein is illustrated in terms of WAPS in which multiple towers broadcast synchronized positioning signals to UEs and, more particularly, using towers that are terrestrial. However, the embodiments are not so limited, and other systems within the spirit and scope of the disclosure may also be implemented.

In an exemplary embodiment, a WAPS system uses coded modulation sent from a tower or transmitter, such as transmitter, called spread spectrum modulation or pseudo-noise (PN) modulation, to achieve wide bandwidth. The corresponding receiver unit, such as receiver, includes one or more modules to process such signals using a despreading circuit, such as a matched filter or a series of correlators. Such a receiver produces a waveform which, ideally, has a strong peak surrounded by lower level energy. The time of arrival of the peak represents the time of arrival of the transmitted signal at the receiver. Performing this operation on a multiplicity of signals from a multiplicity of towers, whose locations are accurately known, allows determination of the receivers location via trilateration. Various additional details related to WAPS signal generation in a transmitter, along with received signal processing in a receiver are described herein or in the incorporated references.

Transmitters may include various blocks for performing associated signal reception and/or processing. For example, a transmitter may include one or more GPS modules for receiving GPS signals and providing location information and/or other data, such as timing data, dilution of precision (DOP) data, or other data or information as may be provided from a GPS or other positioning system, to a processing module. Other modules for receiving satellite or terrestrial signals and providing similar or equivalent output signals, data, or other information may alternately be used in various embodiments. GPS or other timing signals may be used for precision timing operations within transmitters and/or for timing correction across the WAPS system.

Transmitters may also include one or more transmitter modules (e.g., RF transmission blocks) for generating and sending transmitter output signals as described subsequently herein. A transmitter module may also include various elements as are known or developed in the art for providing output signals to a transmit antenna, such as analog or digital logic and power circuitry, signal processing circuitry, tuning circuitry, buffer and power amplifiers, and the like. Signal processing for generating the output signals may be done in the a processing module which, in some embodiments, may be integrated with another module or, in other embodiments, may be a standalone processing module for performing multiple signal processing and/or other operational functions.

One or more memories may be coupled with a processing module to provide storage and retrieval of data and/or to provide storage and retrieval of instructions for execution in the processing module. For example, the instructions may be instructions for performing the various processing methods and functions described subsequently herein, such as for determining location information or other information associated with the transmitter, such as local environmental conditions, as well as to generate transmitter output signals to be sent to the user devices.

Transmitters may further include one or more environmental sensing modules for sensing or determining conditions associated with the transmitter, such as, for example, local pressure, temperature, or other conditions. In an exemplary embodiment, pressure information may be generated in the environmental sensing module and provided to a processing module for integration with other data in transmitter output signals as described subsequently herein. One or more server interface modules may also be included in a transmitter to provide an interface between the transmitter and server systems, and/or to a network infrastructure.

Receivers may include one or more GPS modules for receiving GPS signals and providing location information and/or other data, such as timing data, dilution of precision (DOP) data, or other data or information as may be provided from a GPS or other positioning system, to a processing module (not shown). Of course, other Global Navigation Satellite Systems (GNSS) are contemplated, and it is to be understood that disclosure relating to GPS may apply to these other systems. Of course, any location processor may be adapted to receive and process position information described herein or in the incorporated references.

Receivers may also include one or more cellular modules for sending and receiving data or information via a cellular or other data communications system. Alternately, or in addition, receivers may include communications modules for sending and/or receiving data via other wired or wireless communications networks, such as Wi-Fi, Wi-Max, Bluetooth, USB, or other networks.

Receivers may include one or more position/location modules for receiving signals from terrestrial transmitters, and processing the signals to determine position/location information as described subsequently herein. A position module may be integrated with and/or may share resources such as antennas, RF circuitry, and the like with other modules. For example, a position module and a GPS module may share some or all radio front end (RFE) components and/or processing elements. A processing module may be integrated with and/or share resources with the position module and/or GPS module to determine position/location information and/or perform other processing functions as described herein. Similarly, a cellular module may share RF and/or processing functionality with an RF module and/or processing module. A local area network (LAN) module may also be included.

One or more memories may be coupled with processing module and other modules to provide storage and retrieval of data and/or to provide storage and retrieval of instructions for execution in the processing module. For example, the instructions may perform the various processing methods and functions described herein or in the incorporated references.

Receivers may further include one or more environmental sensing modules (e.g., inertial, atmospheric and other sensors) for sensing or determining conditions associated with the receiver, such as, for example, local pressure, temperature, movement, or other conditions, that may be used to determine the location of the receiver. In an exemplary embodiment, pressure information may be generated in such an environmental sensing module for use in determining location/position information in conjunction with received transmitter, GPS, cellular, or other signals.

Receivers may further include various additional user interface modules, such as a user input module which may be in the form of a keypad, touchscreen display, mouse, or other user interface element. Audio and/or video data or information may be provided on an output module (not shown), such as in the form or one or more speakers or other audio transducers, one or more visual displays, such as touchscreens, and/or other user I/O elements as are known or developed in the art. In an exemplary embodiment, such an output module may be used to visually display determined location/position information based on received transmitter signals, and the determined location/position information may also be sent to a cellular module to an associated carrier or other entity.

The receiver may include a signal processing block that comprises a digital processing block configured to demodulate the received RF signal from the RF module, and also to estimate time of arrival (TOA) for later use in determining location. The signal processing block may further include a pseudorange generation block and a data processing block. The pseudorange generation block may be configured to generate “raw’ positioning pseudorange data from the estimated TOA, refine the pseudorange data, and to provide that pseudorange data to the position engine, which uses the pseudorange data to determine the location of the receiver. The data processing block may be configured to decode the position information, extract packet data from the position information and perform error correction (e.g., CRC) on the data. A position engine of a receiver may be configured to process the position information (and, in some cases, GPS data, cell data, and/or LAN data) in order to determine the location of the receiver within certain bounds (e.g., accuracy levels, etc.). Once determined, location information may be provided to applications. One of skill in the art will appreciate that the position engine may signify any processor capable of determining location information, including a GPS position engine or other position engine.

### Variations of Implementation

Methods for time synching with a GPS network of satellites in an environment that contains obstructions disposed between a receiver and certain satellites of the GPS network may: identify a plurality of regions defined by a respective range of azimuths associated with a first position in the environment, wherein the viewing regions extend radially outward from the first position along a reference plane of the environment; identify, for each region, a minimum elevation angle at which at least one satellite will be visible from the first position at some point in time during the operation of the GPS network; and track one or more satellites corresponding to one or more azimuths that are visible above one or more minimum elevation angles of one or more regions that corresponding to the one or more azimuths. In accordance with certain aspects, the minimum elevation angle is identified based on heights of one or more obstructions in the region. The methods may: track a first satellite that is visible above a first minimum elevation angle of a first region corresponding to a first azimuth; and track a second satellite that is visible above a second minimum elevation angle of a second region corresponding to a second azimuth. In accordance with certain aspects, the first minimum elevation angle is based on a first height of a first obstruction at the first azimuth. In accordance with certain aspects, the second minimum elevation angle is based on a second height of a second obstruction at the second azimuth. In accordance with certain aspects, the first and second minimum elevation angles are different because the first and second heights are different.

The various components, modules, and functions described herein can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include: microcontrollers with memory (such as electronically erasable programmable read only memory (EEPROM)), embedded microprocessors, firmware, software, etc. Furthermore, aspects of the systems and methods may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, HTTPs, FTP, SMTP, WAP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods is not intended to be exhaustive or to limit the systems and methods to the precise forms disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other systems and methods, not only for the systems and methods described above. The elements and acts of the various embodiments described above can be combined to provide further embodiments. These and other changes can be made to the systems and methods in light of the above detailed description.

One of skill in the art will appreciate that the processes shown in the Drawings and described herein are illustrative, and that there is no intention to limit this disclosure to the order of stages shown. Accordingly, stages may be removed and rearranged, and additional stages that are not illustrated may be carried out within the scope and spirit of the invention.

In one or more exemplary embodiments, the functions, methods and processes described may be implemented in whole or in part in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer.

By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The various illustrative logical blocks, modules, processes, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps or stages of a method, process or algorithm in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the disclosure is not intended to be limited to the aspects shown herein but is to be accorded the widest scope consistent with the appended claims and their equivalents.

As used herein, computer program products comprising computer-readable media including all forms of computer-readable medium except, to the extent that such media is deemed to be non-statutory, transitory propagating signals.

While various embodiments of the present invention have been described in detail, it may be apparent to those skilled in the art that the present invention can be embodied in various other forms not specifically described herein. Therefore, the protection afforded the present invention should only be limited in accordance with the following claims.

1. A method for time synching to a network of satellites in an environment that contains obstructions disposed between a receiver and one or more of the satellites at different instances of time, the method comprising:
identifying two or more regions that extend outward from a receiver along a reference plane, wherein each of the two or more regions is defined by a different range of azimuths;
identifying two or more minimum elevation angles, wherein each of the two or more minimum elevation angles correspond to a different region from the two or more regions; and
tracking a satellite that is above at least one of the two or more minimum elevation angles.

2. The method of claim 1, the method further comprising:
tracking a first satellite that is visible only above a first minimum elevation angle of a first region corresponding to a first range of azimuths; and
tracking a second satellite that is visible only above a second minimum elevation angle of a second region corresponding to a second range of azimuths.

3. The method of claim 2, wherein the first minimum elevation angle is based on a first height of a first obstruction that is located within the first range of azimuths, and the second minimum elevation angle is based on a second height of a second obstruction that is located within the second range of azimuths, wherein the first height and the second height are different.

4. The method of claim 1, the method further comprising:
identifying a frequency adjustment applied to a frequency setting of a remote oscillator that is co-located with a remote receiver to which at least one of the satellites is visible; and
using the frequency adjustment to cause an adjustment to a frequency setting of an oscillator that is co-located with the receiver.

5. The method of claim 4, wherein the frequency adjustment is used to adjust the frequency setting of the oscillator when none of the satellites are visible to the receiver.

6. The method of claim 5, wherein the frequency adjustment synchronizes the remote oscillator to a timing signal received by the remote receiver from the network of satellites.

7. The method of claim 0, the method further comprising:
identifying a change in operating temperature of the oscillator;
determining an additional frequency adjustment that corresponds to the change in operating temperature; and
using the additional frequency adjustment to cause an adjustment to the frequency setting of the oscillator.

8. The method of claim 7, wherein the additional frequency adjustment is determined based on recorded changes in the frequency of the oscillator corresponding to changes in operating temperatures of the oscillator when at least one satellite was visible to the receiver.

9. The method of claim 1, the method further comprising:
identifying a change in operating temperature of an oscillator that is co-located with the receiver;
determining a frequency adjustment that corresponds to the change in operating temperature; and
using the frequency adjustment to adjust a frequency setting of the oscillator.

10. The method of claim 9, wherein the change in operating temperature is identified, and the frequency adjustment is determined and used to adjust the frequency setting of the oscillator, when none of the satellites are visible to the receiver.

11. The method of claim 9, wherein the additional frequency adjustment is determined based on recorded changes in the frequency of the oscillator corresponding to changes in operating temperatures of the oscillator when at least one satellite was visible to the receiver.

12. A system comprising one or more processors that perform the method of claim 1.

13. A non-transitory machine-readable medium embodying program instructions adapted to be executed to implement the method of claim 1.
